(19) United States
(12) Patent Application Publication
(10) Pub. No.: US 2006/0053393 A1
(43) Pub. Date: Mar. 9, 2006

(54) Method of improving routes of nets in circuits

(76) Inventors: Christopher R. Cowan, Fort Collins, CO (US); C. Alva Barney, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/934,165

(22) Filed: Sep. 3, 2004

(51) Int. Cl. G06F 17/50

(52) U.S. Cl. 716/2; 716/12

(57) ABSTRACT

One disclosed method for improving the route of at least one net of a circuit comprises: receiving a circuit design that includes a plurality of circuit elements and at least one communication carrier element; determining a location for each circuit element; determining an original route for the communication carrier element; classifying the original route of the communication carrier element as either suspect or non-suspect; and re-establishing a route for the communication carrier elements that are classified as suspect.

### FIELD OF THE INVENTION

This invention relates in general to circuit design and more particularly to a system and method for improving the nets in circuits by analyzing placement module routes and routing module routes.

### DESCRIPTION OF RELATED ART

When designing circuits, managing route congestion among the various parts of a circuit is key to the success of the design. However, managing route congestion can be very complex as modem circuits, such as integrated circuits, typically include thousands of individual pieces or cells to be connected. Thus, in order to effectively manage such congestion, circuit designers often use some type of electronic design automation (EDA) system.

In using an EDA system, a circuit designer will typically produce some type of high-level description, such as VHDL, of the circuit. After this high-level description is produced, some type of compiler may convert the high-level description into another description of the circuit that specifies the cells that make up the circuit, such as a netlist. Yet, the netlist does not specify where the various cells are to be placed on a circuit board or silicon chip.

After the netlist has been synthesized, the synthesized design undergoes a layout process using place-and-route tools so that the circuit may be manufactured. The layout process consists of two primary functions: determining the positions or “placement” of the cells on a layout surface, and interconnecting the components with wiring, or routing. The placement process basically finds a location for each cell on a circuit base, such as a silicon chip or circuit board. After the placement process generates a location for all cells, the routing process will use this location information to generate a geometric structure or layout of the wires for connecting the various cells to one another. However, imprecise or inefficient wiring layouts produced by the routing process may cause problems, such as increased resistance levels and increased capacitance levels which often lead to increased timing failures.

### BRIEF SUMMARY OF THE INVENTION

According to at least one embodiment, a method for improving a route of at least one net of a circuit is provided. The method comprises receiving a circuit design that comprises a plurality of circuit elements and at least one communication carrier element; determining a location for the circuit elements; determining an original route for a communication carrier element; classifying the original route of the communication carrier element as one of (a) suspect and (b) non-suspect; and re-establishing a route for the communication carrier element if the original route of the communication carrier element has been classified as suspect.

According to at least one embodiment, a method is provided that comprises monitoring a correlation between an estimated route length and a detailed route length; and utilizing the monitored correlation to identify critical nets.

According to at least one embodiment, a computer program product having a computer readable medium including computer program logic recorded thereon is provided. The computer program product comprises code for monitoring a correlation between an estimated route length and a detailed route length; and code for utilizing the monitored correlation to identify critical nets.

### BRIEF DESCRIPTION OF THE DRAWINGS

FIG. 1 is an illustration of a general architecture of a system of an embodiment for improving routes of nets in circuits;

FIG. 2 is a flowchart illustrating steps executed for improving routes of nets in circuits, according to one embodiment;

FIG. 3 is a flowchart illustrating steps executed for improving routes of nets in circuits, according to another embodiment; and

FIG. 4 depicts a block diagram of a computer system which is adapted to use an embodiment for improving routes of nets in circuits.

### DETAILED DESCRIPTION

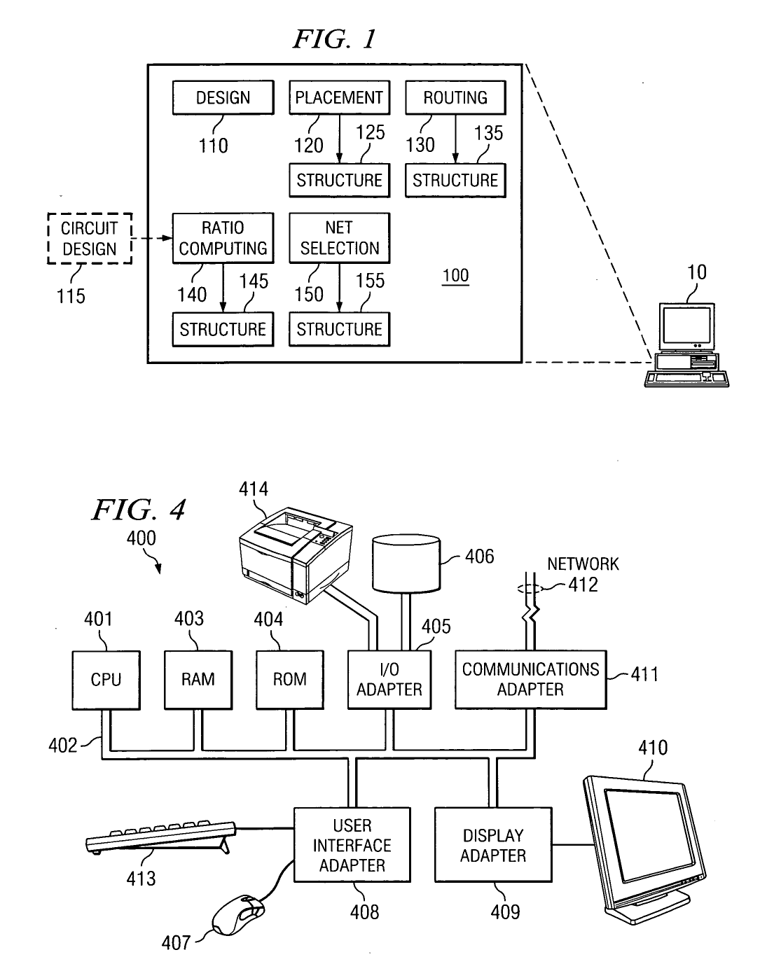

FIG. 1 is a diagram illustrating route improvement environment 100 implemented on computer 10 for improving the routes of nets in circuits. A net is the physical communication carrier element used to connect one cell to another cell, such as physical wiring, metal traces on a printed circuit board, and the like. For example, if an output from an AND gate is to be connected to the input of a NAND gate, then the net could be a physical wiring or a metal trace that would connect the AND gate to the NAND gate so that signals from the AND gate can be communicated to the NAND gate. The path or route that a net follows in making a connection from one cell to another cell varies depending on the layout of the circuit. Accordingly, the length of the path or route of a net will also vary.

In addition to route improvement environment 100, computer system 10 may include an operating system, a computer's coordinating program that is built on the instruction set for a processor or a microprocessor, and the hardware that performs the logic operations and manages the data movement of the computer. Route improvement environment 100 represents one application or a portion of an application running on computer 10. In one embodiment, route improvement environment 100 may include design module 110, placement module 120, routing module 130, ratio computing module 140, and net selection module 150.

Design module 110 works with the design of a circuit. For example, design module 110 may take a high-level description of a circuit in a hardware description language, such as VHDL, and convert this high-level description into a netlist design or design module 110 may simply receive a netlist design from a circuit designer. For example, a circuit designer may create a netlist by hand and then input that netlist into route improvement environment 100. A netlist is a description of the circuit that specifies the various cells that make up the circuit and specifies how the various cells are to be connected in a logical sense. However, in alternative embodiments, design module 110 may be part of another application that may not be part of route improvement environment 100.

Placement module 120 operates to find a location for each cell or circuit element included in a circuit design. For example, placement module 120 can find a location for circuit elements, such as a NAND or AND gate, that make up an integrated circuit on a silicon chip or that make up a circuit that is implemented on a circuit board. The locations may be specified in two-dimensional spatial coordinates, such as X and Y coordinates, whereby the locations are preferably selected in order to optimize certain features, such as congestion, timing, routability, power consumption, and the like. In addition to determining locations for each cell or circuit element, placement module 120 will also analyze the circuit and generate routes for the various nets of the circuit. The routes generated by placement module 120 are estimated routes. The estimated routes are a general path for the nets whereby the general path is a determination of a rough pathway from a topological standpoint. Thus, placement module 120 will generate estimated routes for the various nets that are based on a topological standpoint. The estimated route provides a rough estimate of the length of the communication carrier element, such as a wire or metal trace, for the path or route of the nets. Thus, placement module 120 performs a rough or course level of routing, also known as global routing, for the nets of the circuit in addition to determining a location for each cell element. For example, rough or course routing may be achieved by various applications, such as SYNOPSIS™ INC's Physical Compiler®, CADENCE™ DESIGN SYSTEMS, INC.'s Physically Knowledgeable Synthesis (PKS), and the like.

In alternative embodiments, placement module 120 may be part of another application that may not be part of route improvement environment 100. For example, placement module 120 may be an external application whereby the locations for each cell and the estimated route may be input from this external application into route improvement environment 100.

In addition, placement module 120 may also generate location data structure 125. Location data structure 125 may include a layout structure and a route structure. The layout structure may specify the location for each cell of the circuit design, and the route structure may specify an estimated route for each net of the circuit design. Placement module 120 may output the layout structure and the route structure as two separate data structures or as one combined data structure. In addition, route improvement environment 100 may output location data structure 125 in several configurations. For example, location data structure 125 may be output in the form of one or more of a physical media output, such as a paper printout; a data display on a computer screen; data stored in processor readable medium, such as a semiconductor memory device, a ROM, a flash memory, an erasable ROM (EROM), a floppy diskette, a compact disk CD-ROM, an optical disk, a hard disk, and the like.

Routing module 130 operates to determine the geometric locations of the nets connecting the various cells of the circuit to one another. In determining the locations of the nets of a circuit, routing module 130 may route the nets completely differently than the global routes estimated by placement module 120, for various reasons. For example, routing module 130 may route some of the nets completely different due to the severity of congestion in the circuit design, and placement module 120 may not have had an accurate view of how many routing tracks or routing resources were available. Besides determining the locations of the nets, routing module 130 will also determine the actual length of the communication carrier element, such as a wire or metal trace, for the routes of nets. In addition, routing module 130 may also generate route data structure 135. Route data structure 135 is preferably a data structure, such as a report, that specifies the actual route and length of each net. Route improvement environment 100 may output route data structure 135 in several configurations. For example, route data structure 135 may be output in the form of one or more of a physical media output, such as a paper printout; a data display on a computer screen; data stored in processor readable medium, such as a semiconductor memory device, a ROM, a flash memory, an erasable ROM (EROM), a floppy diskette, a compact disk CD-ROM, an optical disk, a hard disk, and the like.

In alternative embodiments, routing module 130 may be part of another application that may not be part of route improvement environment 100. For example, routing module 130 may be an external application whereby the geometric locations of the nets and the actual length of the communication carrier elements of the nets may be input from this external application into route improvement environment 100. In addition, route improvement environment 100 may be configured in various embodiments so that placement module 120 and routing module 130 are merged into one operational module. This merged module would perform two routing processes, a course routing process and a detail routing process. The course routing process may provide a simple general path for the routing of the nets that will later undergo routing by the fine routing process. Thus, the course router of the merged module may examine the circuit from a topological standpoint and generate rough pathways for the nets. After the rough routes are generated, the detail routing process may analyze the rough routes and generate actual routes and actual lengths of the routes of the nets of the circuit so that timing requirements are met and there are no design violations.

Ratio computing module 140 will compute a ratio between the estimated length of the communication carrier element of a route for a net and the actual length of the communication carrier element of the same route for the same net. By computing a length ratio between the estimated and actual lengths, the lengths of the nets or routes generated from the placement engine, or estimated net lengths, and the length of the nets or routes generated from the routing engine, or actual net lengths, are tracked. Tracking the lengths of the nets helps to identify critical nets that have a high potential for optimization. The computed length ratio helps to identify nets that have actual length values that are longer than their estimated values. In an ideal situation, the ratio of lengths is equal to one, which would indicate that the estimated length of the net is equal to the actual length of the net. In addition, ratio computing module 140 can help classify nets as suspect. Suspect nets are nets that may not meet timing requirements. For example, long nets often have higher resistance and capacitance characteristics than short nets, and these characteristics adversely affect timing requirements. Accordingly, longer nets often classify as nets that may not meet timing requirements. Thus, a ratio that identifies a net as having a communication carrier element with an actual length value that is larger than the estimated length value of the communication carrier element may signal that the net is suspect. Therefore, the net should be optimized by an optimization process, such as re-routing the net, in an attempt to reduce the possibility of the net not meeting timing requirements.

In one embodiment, ratio computing module 140 computes a ratio as a comparison of the estimated length of a net route generated by placement module 120 to the actual length of the net route generated by routing module 130. Thus, the ratio computed by ratio computing module 140 is the quotient of the length of the route generated by placement module 120 to the length of the route generated by routing module 130. In this embodiment, a small value of the ratio, less than one, helps to indicate that the actual length of the route of a net is larger than the estimated length of the route for the net, which in turn may indicate that the corresponding net is a suspect net. Accordingly, the larger the value of the ratio, up to and including a value of one, helps to indicate that the actual length of the route of a net may be closer to the estimated length of the route for the corresponding net, which in turn may indicate that the net is a non-suspect net. For example, if routing module 130 generated an actual length or route_length for net A of 10 and placement module 120 generated an estimated length or placement_length for net A of 2, then the ratio computed by ratio computing module 140 would be as follows:

Example 1:
[placement_length of net A/route_length of net A] is 2/10=0.2.

Thus, the value 0.2 of example 1 indicates that net A may be a suspect net as the small value of the ratio indicates that the actual length of the communication carrier element of net A is larger than the estimated length of the communication carrier element of net A.

In another embodiment, ratio computing module 140 computes a ratio as a comparison of the actual length of the net route generated by routing module 130 to the estimated length of a net route generated by placement module 120. Thus, the ratio computed by ratio computing module 140 is the quotient of the length of the route generated by routing module 130 to the length of the route generated by placement module 120. In this embodiment, a larger value of the ratio, greater than one, helps to indicate that the actual length of the route of a net is larger than the estimated length of the route for the net, which in turn may indicate that the corresponding net is a suspect net. Accordingly, a smaller value of the ratio, down to and including a value of one, helps to indicate that the actual length of the route of a net may be closer to the estimated length of the route for the corresponding net, which in turn may indicate that the net is a non-suspect net. For example, if routing module 130 generated an actual length or route_length for net B of 10 and placement module 120 generated an estimated length or placement_length for net B of 2, then the ratio computed by ratio computing module 140 would be as follows:

Example 2:
[route_length of net B/placement_length of net B] is 10/2=5.

Thus, the value of 5 of example 2 indicates that net B may be a suspect net as the large value of the length ratio indicates that the actual length of the communication carrier element of net B is larger than the estimated length of the communication carrier element of net B.

The computed ratio may be output as ratio data structure 145. Ratio data structure 145 may be output in the form of one or more of a physical media output, such as a paper printout; a data display on a computer screen; data stored in processor readable medium, such as a semiconductor memory device, a ROM, a flash memory, an erasable ROM (EROM), a floppy diskette, a compact disk CD-ROM, an optical disk, a hard disk, and the like.

Net selection module 150 examines the nets of a circuit design and identifies the various nets as either a suspect net or a non-suspect net. If a net is labeled suspect, then the net is ideal for optimization through various processes, such as a re-routing process. Thus, suspect nets may be re-routed through routing module 130.

Nets are labeled suspect based on a set of flexible heuristics. The heuristics employed in net selection module 150 may comprise any one or more of various conditions, such as a value of the length ratio, such as the length ratio computed by ratio computing module 140, indicating that the actual length of a net is longer than the estimated length of the net, a threshold net length value, a total number of nets, a total number of nets previously selected for optimization, the name of a net, the classification of a net, the particular collection of shapes making up a route of a net, and the like. For example, if a net does not meet a threshold length, then the net will not be classified as a suspect net regardless of the value of the length ratio. The threshold length heuristic may also be used so that once the length of a net reaches a certain value, the net may be classified as suspect even if the value of the length ratio is small. For example, once the actual length of a net is greater than or equal to a certain length, then the net may be labeled suspect even if the value of the length ratio indicates that the actual net length is only 1.5 times the estimated length of the net.

The number of nets may also be used to help govern when nets are suspect. For example, net selection module 150 may be configured so that once route improvement environment 100 has classified a certain maximum number of nets as suspect, then no other nets will be labeled suspect. For example, if a maximum number of suspect nets has been set at 40, then after the 40 worst nets have been classified as suspect, then no other nets will be labeled suspect regardless of the characteristics of the remaining nets. In addition, the name or classification of a net may also be used in governing which nets are labeled suspect. For example, net selection module 150 may be configured so that whenever a net from a particular class or having a certain name is examined, that net will not be labeled suspect regardless of the value of the length ratio heuristic.

Once net selection module 150 has classified the nets as suspect, a list of the suspect nets may be output as suspect net data structure 155. Net data structure 155 may be output in various configurations, such as output to another module of route improvement environment 100; output in a physical media output format, such as a paper printout; in a data display on a computer screen; in data stored in processor readable medium, such as a semiconductor memory device, a ROM, a flash memory, an erasable ROM (EROM), a floppy diskette, a compact disk CD-ROM, an optical disk, a hard disk, and the like.

FIG. 1 illustrates one embodiment for improving the routes of nets that may be created by a placement engine and a routing engine. Thus, alternative embodiments of FIG. 1 may be configured so that route improvement environment 100 includes more or less modules that those illustrated in FIG. 1. For example, in an alternative embodiment, route improvement environment 100 may be configured to only include ratio computing module 140 and net selection module 150. In such an embodiment, a circuit design 115 that may have already been processed by a synthesis/placement and/or routing module, such as placement module 120 and routing module 130, may be input to ratio computing module 140. For example, in such an embodiment, circuit design 115 may be input from another application into ratio computing module 140 whereby the other application has already processed the circuit design through a placement and routing module.

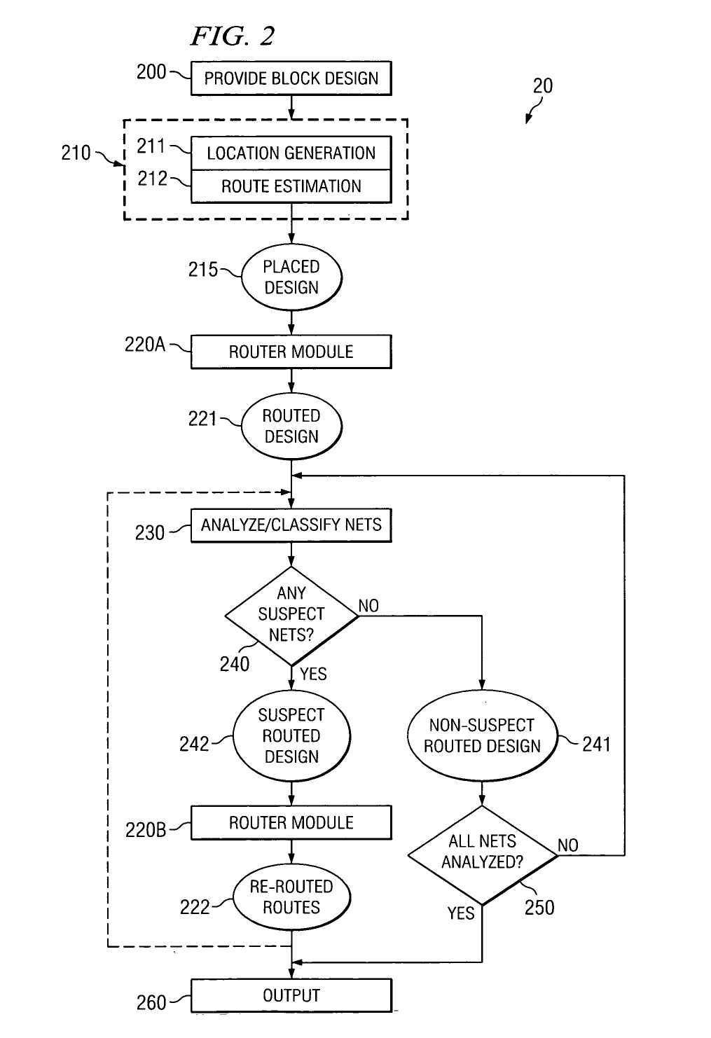

FIG. 2 depicts a flowchart illustrating an operational flow 20 for improving the length of routes of nets, according to one embodiment. In block 200, a block design of a circuit is provided. A block design may be an RTL model and floor plan of a particular portion of a circuit design. For example, the floor plan may include the size and shape of the particular portion of the circuit, the ground wires, ports or wires which will interface with another portion of the circuit, and any pre-routed wires of the particular portion of the circuit design under analysis. The block design may be provided by design module 110 of FIG. 1 or by some other circuit design application. Once a circuit design is provided, flow 20 proceeds to block 210.

In block 210, the block design of the circuit is processed by a placement module, such as placement module 120 of FIG. 1. Block 210 may consist of two operations illustrated by sub-blocks 211 and 212. In sub-block 211, all circuit elements or instances (standard library cells) are assigned a physical location whereby the physical locations of the various circuit elements may be assigned in terms of two-dimensional spatial coordinates, such as X and Y coordinates. In sub-block 212, an estimated route or global route is generated for the various nets of the block design. The global route generated may also contain an estimated route length of the communication carrier element of the nets of the block design. After the block design of the circuit has been processed by sub-blocks 211 and 212 in block 210, a “placed design,” illustrated by element 215, is output from block 210 and is passed on to block 220A. A “placed design” is the block design of the circuit in which all instances or circuit elements have physical locations.

After block 210, flow 20 proceeds to block 220A and “placed design” 215 is input to block 220A. In block 220A, the “placed design” 215 is processed by a routing module, such as routing module 130 of FIG. 1. During processing of the “placed design” 215 in block 220A, geometric locations will be established for the various nets connecting the various cells, circuit elements, or instances of the circuit to one another. In addition, the actual length of the communication carrier elements for the routes of the nets will also be generated during block 220A. In an alternative embodiment, a route data structure, such as route data structure 135 of FIG. 1, may also be generated during block 220A. After the “placed design” 215 has been processed in block 220A, a “routed design,” illustrated by element 221, is output from block 220A and passed on to block 230. A “routed design” is the block design of the circuit in which all circuit elements or instances have physical locations and all connections between the circuit elements or instances have physical routes between them.

After block 220A, flow 20 proceeds to block 230 where “routed design” 221 is input to block 230. In block 230, the “routed design” is analyzed and the nets of the routed design will be classified as either suspect or non-suspect based on various flexible heuristics, such as the flexible heuristics discussed above with respect to FIG. 1. The heuristics employed in block 230 may comprise any one or more of various conditions, such as a value of the length ratio indicating that the actual length of a net is longer than the estimated length of the net, a threshold net length value, a total number of nets, a total number of nets previously selected for optimization, the name of a net, the classification of a net, the particular collection of shapes making up a route of a net, and the like. After the nets of the “routed design” are classified in block 230, flow 20 proceeds to query block 240.

In query block 240, a query is run to determine if any nets of “routed design” 221 have been classified as suspect. A suspect net is a net that is sub-optimal and may not meet timing requirements for various reasons, such as the length of the communication carrier element, such as wire or metal trace, of the route of the net is too long, the net is not arranged in the shortest path, and the like. If the results of query 240 determine that none of the nets of “routed design” 221 are suspect, then routed design will be passed on as a non-suspect design illustrated by element 241, and flow 20 will proceed on to query block 250. In query block 250, a query is run to determine if all nets have been analyzed. If the results of query 250 indicate that all the nets have not been analyzed, then flow 20 will flow back to block 230 where the net or nets that have not been analyzed can be analyzed in order to determine if the net or nets are suspect or non-suspect based on the flexible heuristics. If the results of query block 250 indicate that all nets have been analyzed, then flow 20 will proceed on to block 260.

However, if the results of query 240 determine that “routed design” 221 includes a suspect net, then flow 20 proceeds on to block 220B. Element 242 illustrates that “routed design” 221 is classified as suspect illustrated by “suspect routed design” 242. “Suspect routed design” 242 will be input to block 220B. In block 220B, “suspect routed design” 242 is processed by a routing module, such as routing module 130 of FIG. 1. During processing of the “suspect routed design” 242 in block 220B, geometric locations will be re-established for the suspect nets connecting the various circuit elements or instances of the circuit to one another, and the actual length of the communication carrier element, such as wire or metal trace, of the route of each net will also be re-generated during block 220B. After “suspect routed design” 242 has been optimized or re-routed in block 220B, a re-routed or optimized design, illustrated by an optimized or “re-routed design” 222, that is different than “suspect routed design” 242 is output from block 220B. Thus, by processing “suspect routed design” 242 through block 220B, the “routed design” 221 has been optimized.

After block 220B, flow 20 proceeds to block 260. In block 260, the block design resulting from flow 20 from either block 220B or query block 250 may be prepared for output in various forms, such as a data structure to be stored in memory, to be passed on to various applications, such as various third party circuit manufacturing applications, and the like. For example, if flow 20 operated so that “re-routed design” 222 was input to block 260, then “re-routed design” 222 would be output through block 260, and if flow 20 operated so that no suspect nets were detected, then “routed design” 221 would be passed on through flow 20 illustrated by “non-suspect routed design” 241 that would be output through block 260.

In an alternative embodiment, flow 20 may be configured so that flow 20 flows from block 220B back into block 230 in order to analyze the net of “re-routed design” 222 to determine if “re-routed design” 222 still includes any suspect nets. If the “re-routed design” 222 includes any suspect nets after being re-routed in block 220B, then “re-routed design” 222 may be re-routed again and again until all suspect nets have been optimized so that “re-routed design” 222 does not include any suspect nets or so that “re-routed design” 222 cannot be optimized anymore. In such an embodiment, “non-suspect routed design” 241 would include a block design of a circuit that has been re-routed.

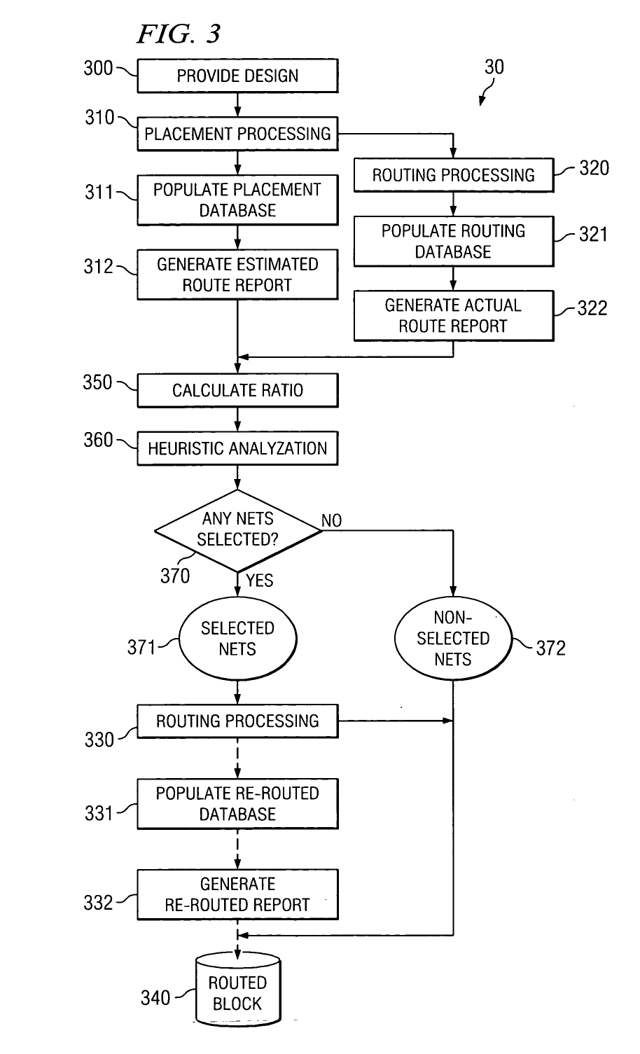

FIG. 3 depicts a flowchart illustrating an operational flow 30 for improving the routing of nets in circuit designs by monitoring the correlation between the length of net routes generated by a placement module and the length of net routes generated by a routing module, according to another embodiment.

In block 300, a circuit design is provided. The provided circuit design may be a design describing an RTL model and floor plan of a circuit. The circuit design may be provided by design module 110 of FIG. 1 or by some other circuit design application. Once a circuit design is provided, flow 30 proceeds to block 310.

In block 310, the circuit design is processed by a placement module, such as placement module 120 of FIG. 1. During placement processing in block 310, all instances or circuit elements of the circuit design will be assigned a physical location. In addition, placement processing will also generate a global route for the various nets of the circuit design. The global route generated in block 310 is a rough estimate of the length of the various routes of the nets. After block 310, flow 30 proceeds to block 311 and block 320.

In block 311, a placement database is populated. The placement database is populated with information related to the global routes generated during placement processing in block 310. The information will contain information from a placement module about the estimated lengths of the various routes of the nets. For example, the placement database may include a list of the nets of the circuit and a corresponding list of the estimated length of the routes for the nets. After the placement database is populated in block 311, flow 30 proceeds on to block 312. In block 312, a report is generated that contains information related to the global or estimated route.

In block 320, the circuit design that underwent placement processing in block 310 will be processed by a routing module, such as routing module 130 of FIG. 1. During route processing in block 320, detailed routes will be established for the various nets of the circuit. The detailed routes will include geometric locations that are established for the various nets connecting the various circuit elements or instances of the circuit to one another. In addition, the actual length of the various routes of the nets will also be generated during block 320. After block 320, flow 30 will proceed to block 321.

In block 321, a routing database is populated. The routing database is populated with information related to the detailed routes generated during route processing in block 320. The information will contain information from a routing module about the actual physical lengths of the various routes of the nets. For example, the routing database may include a list of the nets of the circuit and a corresponding list of the actual physical length of the routes for the nets. After the routing database is populated in block 321, flow 30 proceeds on to block 322. In block 322, a report is generated that contains information related to the detailed routes.

After blocks 312 and 322, flow 30 proceeds to block 350. In block 350, a ratio between the length associated with the estimated or global route and the length associated with the detailed route is calculated. The calculated ratio or length ratio will help to identify nets that have an actual route length that is greater than the corresponding estimated route length. In one embodiment, block 350 may be configured so that the ratio is calculated as the quotient of the estimated route length over the actual route length. In such an embodiment, a small ratio value, less than one, indicates that the actual route length is greater than the estimated route length. In another embodiment, block 350 may be configured so that the ratio is calculated as the quotient of the actual route length over the estimated route length. In such an embodiment, a large ratio value, greater than one, indicates that the actual route length is greater than the estimated route length.

The calculating of length ratios is advantageous as it helps identify nets that have an actual length value that is greater than the corresponding estimated route length. In addition, the calculated length ratio provides a way to track the correlation between the estimated length value and the actual length value. By identifying nets that have an actual length value that is greater than the estimated length value and by tracking the correlation among the two length values, nets may be identified as critical whereby critical nets are nets that have a high potential for optimization. After the critical nets are identified, they can be reprocessed or optimized in an attempt to shorten the actual route lengths. For example, critical nets may be optimized by a re-routing process whereby the critical nets are re-routed a second time.

After block 350, flow 30 proceeds to block 360. In block 360, nets of a circuit design will be analyzed and selected for optimization based on a heuristic analyzation process based on a flexible set of heuristics. The flexible set of heuristics may comprise any one or more of various conditions, such as a length ratio calculated in step 350, a threshold actual net length value, a total number of nets, a total number of nets previously selected for optimization, the name of a net, the classification of the net, the particular collection of shapes making up a route of a net, and the like. In addition, the heuristic analyzation process may query the placement database and/or the routing database for various information pertaining to the estimated route length and actual route length. This information may then be used in analyzing the nets of the circuit design and determining if the nets are optimal or non-optimal. The placement database and routing database may be queried in the heuristic analyzation process as both databases contain specific information related to the routes of nets. Physically, the route of a net is a collection of shapes on different metal layers of the circuit, and this information associated with the collection of shapes for the route of a net is included in both the placement database and the routing database. Thus, the heuristic analyzation process may query both databases in order to take this information into consideration when selecting the nets as an optimal or non-optimal net.

After block 360, flow 30 proceeds to query block 370. In query block 370, a query is run to determine if any nets of the analyzed circuit design have been selected (based on the heuristic analyzation of block 360) as non-optimal nets that need to be optimized. If the results of query block 370 indicate that no nets have been selected as non-optimal nets that are to be optimized, then the circuit design that does not contain any non-optimal nets, illustrated by element 372, will be input to block 340. If any nets of the circuit design are selected as a non-optimal net that is to be optimized, then the circuit design containing the selected non-optimal net or nets, illustrated by element 371, will be input to block 330.

In block 330, the circuit design that contains the net or nets to be optimized will be processed a second time or re-routed by a routing module, such as routing module 130 of FIG. 1. During re-route processing in block 330, detailed routes will be re-established for the various nets of the circuit that were selected as non-optimal nets to be optimized. The re-established routes may include new geometric locations that were established for the various nets selected to be optimized that connect the various circuit elements or instances of the circuit to one another. In addition, the actual length of the routes of a net for any re-established routes of nets will also be generated during block 330.

After block 330, flow 30 proceeds to block 340. In block 340, the circuit design input to block 340 may be prepared for output in various forms, such as a data structure to be stored in memory, to be passed on to various applications, such as various third party circuit manufacturing applications, and the like.

For example, a circuit may consist of two circuit blocks designated as block A and block B. Blocks A and B of the circuit may include hundreds to thousands of nets depending on the size of the circuit blocks. As circuit block A is routed through flow 30 and reaches block 360, the results of the heuristic analyzation process of block 360 and the query of block 370 may indicated that block A does not contain any non-optimal nets. Thus, block A may be sent straight to block 340 so that the routed block input to block 340 is the same routed block coming out of block 320. On the other hand, as circuit block B is routed through flow 30 and eventually passed onto block 360, fifty nets of block B may be classified as non-optimal. Thus, these fifty non-optimal nets (selected nets) are to be optimized by a re-routing process. Accordingly, the entire block B will be passed on to block 330 for re-routing. During block 330, only the fifty nets selected (selected nets) as non-optimal should be optimized or re-routed in block 330. However, in order to effectively optimize or re-route the fifty non-optimal or selected nets, some of the other nets (non-selected nets) in block B may have to be moved or re-routed so that the fifty non-optimal or selected nets can be effectively optimized by being re-routed. Thus, the routes of the nets that are moved to accomplish re-routing of the non-optimal or selected nets will also be changed. However, in another embodiment, flow 30 will be configured so that the change resulting from such movement of the non-selected nets in order to effectively re-route the fifty non-optimal or selected routes is minimal. After block B has been re-processed, the output of block 330 is a routed design of block B that is different than the original routed design of block B output by block 320 the first time that block B was routed. By re-routing block B, all possible timing violations may be cured.

In an alternative embodiment, flow 30 may be configured so that flow 30 flows from block 330 to block 331 instead of flowing directly into block 340. In this embodiment, block 331 operates to populate a re-routing database. The re-routing database is populated with information related to the actual re-established routes associated with the nets that were optimized in block 330. The re-routing information will contain information about the actual lengths of the re-routed nets. For example, re-routing database may include a list of the nets of the circuit design that were optimized and a corresponding list of the actual length of these re-routed nets for all optimized routes. In addition, the re-routing database may also include a section that lists information associated with any nets that were not selected to be optimized in block 360, but were moved during block 330 in order to optimize the nets selected for optimization. For example, a first net may not have been selected for optimization, but block 330 may have had to move this first net in order to optimize any nets that were selected for optimization. Thus, the re-routing database may contain information such as before and after route length information associated with the first net. After block 331, flow 30 proceeds to block 332. In block 332, a report is generated that contains information related to the re-routed nets. The report may contain the information in the re-routing database and may also contain additional information that may not be included in the re-routing database such as information from the placement database and/or the routing database.

When route improvement environment 100 of FIG. 1 is implemented in software, the elements of the embodiments are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” or “computer readable medium” may include any medium that can store and/or transfer information. Examples of the processor (or “computer”) readable medium include an electronic circuit, a semiconductor memory device, a ROM, a flash memory, an erasable ROM (EROM), a random access memory (RAM), a floppy diskette, a compact disk CD-ROM, an optical disk, a hard disk, a fiber optic medium, a radio frequency (RF) link, etcetera. The computer data signal may include any signal that can propagate over a transmission medium such as electronic network channels, optical fibers, air, electromagnetic, RF links, etcetera. The code segments may be downloaded via computer networks such as the Internet, Intranet, WAN, LAN, etcetera.

FIG. 4 illustrates computer system 400 adapted to use embodiments for improving routes of nets in circuits, such as computer 10 of FIG. 1, e.g. storing and/or executing software associated with the embodiments. Central processing unit (CPU) 401 is coupled to system bus 402. The CPU 401 may be any general purpose CPU. Embodiments described herein are not restricted by the architecture of CPU 401 as long as CPU 401 supports the inventive operations as described herein. Bus 402 is coupled to random access memory (RAM) 403, which may be SRAM, DRAM, or SDRAM. ROM 404 is also coupled to bus 402, which may be PROM, EPROM, or EEPROM. RAM 403 and ROM 404 hold user and system data and programs as is well known in the art.

Bus 402 is also coupled to input/output (I/O) controller card 405, communications adapter card 411, user interface card 408, and display card 409. The I/O adapter card 405 connects storage devices 406, such as one or more of a hard drive, a CD drive, a floppy disk drive, a tape drive, to computer system 400. The I/O adapter 405 is also connected to printer 414, which would allow the system to print paper copies of information, such as an output of a route report, a re-route report, documents, photographs, articles, etcetera. Note that the printer may be a printer (e.g. dot matrix, laser, etcetera.), a fax machine, scanner, or a copier machine. Communications card 411 is adapted to couple the computer system 400 to a network 412, which may be one or more of a telephone network, a local (LAN) and/or a wide-area (WAN) network, an Ethernet network, and/or the Internet network. User interface card 408 couples user input devices, such as keyboard 413, pointing device 407, etcetera to the computer system 400 to receive various inputs, such as an input of a circuit design or identification of a circuit design like circuit design 115 of FIG. 1. The display card 409 is driven by CPU 401 to control the display on display device 410.

What is claimed is:

1. A method for improving a route of at least one net of a circuit, said method comprising:
receiving a circuit design, wherein said circuit design comprises a plurality of circuit elements and at least one communication carrier element;
determining a location for each of said plurality of circuit elements;
determining an original route for said at least one communication carrier element;
classifying said original route of said at least one communication carrier element as one of (a) suspect and (b) non-suspect; and
re-establishing a route for said at least one communication carrier element if said original route of said at least one communication carrier element has been classified as suspect.

2. The method of claim 1 wherein said method for improving is done electronically.

3. The method of claim 1 further comprising:
generating a data structure.

4. The method of claim 3 wherein said data structure is one or more of:
a location data structure;
a route data structure;
a ratio data structure; and
a net data structure.

5. The method of claim 1 wherein said step of determining a location comprises:
generating a physical location for each of said plurality of circuit elements wherein said physical location is generated in terms of two-dimensional spatial coordinates.

6. The method of claim 5 wherein the spatial coordinates are selected in order to optimize one or more of:
congestion;
timing;
routability; and
power consumption.

7. The method of claim 1 wherein said step of determining an original route comprises:
establishing an estimated route for said at least one communication carrier element; and
establishing a detailed route for said at least one communication carrier element after said estimated route has been established.

8. The method of claim 7 wherein said step of establishing an estimated route comprises:
establishing a rough pathway from a topological standpoint; and
establishing an estimated length for said at least one communication carrier element.

9. The method of claim 7 wherein said step of establishing a detailed route comprises:
establishing geometric locations for said at least one communication carrier element; and
establishing an actual length for said at least one communication carrier element.

10. The method of claim 9 wherein said step of classifying comprises:
establishing a flexible set of conditions;
comparing said at least one communication carrier element to said set of conditions; and
classifying said at least one communication carrier element as suspect if said at least one communication carrier element satisfies one or more of said set of conditions.

11. The method of claim 10 wherein said set of conditions comprises one or more of:
a ratio of said actual length for said at least one communication carrier element to said estimated length for said at least one communication carrier element, wherein said ratio indicates when said actual length is larger than said estimated length;
a threshold length value of a communication carrier element;
a total number of communication carrier elements;
a maximum number of communication carrier elements to be classified as suspect;
a name of a communication carrier element;
a classification of a communication carrier element; and
a collection of shapes making up a route of a communication carrier element.

12. The method of claim 1 wherein said re-establishing step comprises:
establishing a new route for said at least one communication carrier element, wherein said new route is an improved route for said suspect communication carrier element.

13. The method of claim 12 wherein said new route is an improved route if said new route comprises a length of said communication carrier element that is shorter than said original route.

14. The method of claim 12 further comprising:
preparing said circuit design comprising said improved route to be output to an external application; and
outputting said prepared circuit design to said external application.

15. A method comprising:
monitoring a correlation between an estimated route length and a detailed route length; and
utilizing said monitored correlation to identify critical nets.

16. The method of claim 15 wherein said correlation is based on a ratio involving said estimated route length and said detailed route length, wherein said ratio identifies when said detailed route length is larger than said estimated route length.

17. The method of claim 16 wherein said ratio is a quotient of said estimated route length over said detailed route length.

18. The method of claim 16 wherein said ratio is a quotient of said detailed route length over said estimated route length.

19. The method of claim 15 wherein said step of utilizing said monitored correlation to identifying critical nets identifies critical nets of circuit blocks.

20. The method of claim 19 wherein said step of monitoring a correlation comprises:
conducting placement processing of at least one circuit block of said circuit blocks, wherein placement processing operates to establish a location for all elements of said at least one circuit block.

21. The method of claim 20 wherein said step of placement processing further comprises:
generating an estimated route for at least one net of said at least one circuit block, and generating an estimated length for said estimated route.

22. The method of claim 21 further comprising:
populating a placement database with placement data; and
generating an estimated route report.

23. The method of claim 22 wherein said placement data comprises:
information related to said estimated route, wherein said estimated route comprises a collection of shapes on different metal layers of said at least one circuit block.

24. The method of claim 21 wherein said step of monitoring a correlation further comprises:
conducting route processing of said at least one circuit block.

25. The method of claim 24, wherein said route processing comprises:
generating a detailed route for said at least one net of said at least one circuit block; and
generating an actual length for said detailed route.

26. The method of claim 25 further comprising:
populating a routing database with data related to said detailed route; and
generating a detailed route report.

27. The method of claim 26 wherein said data related to said detailed route comprises a collection of shapes on different metal layers of said at least one circuit block.

28. The method of claim 25 wherein said step of monitoring a correlation further comprises:
calculating a ratio between said estimated length for said estimated route and said actual length for said detailed route wherein said calculated ratio identifies if said actual length for said detailed route is greater than said estimated length for said estimated route.

29. The method of claim 28 wherein said step of utilizing said monitored correlation to identifying critical nets further comprises:
establishing a flexible set of heuristics;
comparing at least one net of said at least one circuit block with said heuristics; and
classifying said net as critical if said net satisfies one or more of said heuristics.

30. The method of claim 29 wherein said heuristics comprises one or more of:
a threshold length value for said actual length;
a threshold value of said calculated ratio between said estimated length and said actual length;
a total number of nets;
a maximum number of nets to be classified as critical;
a name of a net;
a classification of a net; and
a collection of shapes making up a route of a net.

31. The method of claim 29 further comprising:
conducting a new route processing of any of said circuit blocks that contain at least one net previously classified as critical.

32. The method of claim 31, wherein said new route processing comprises:
generating a new detailed route for said critical net; and
generating a new actual length for said critical net thereby creating an improved net.

33. The method of claim 32 further comprising:
comparing said improved net with said flexible set of heuristics; and
classifying said new net as critical if said new net satisfies one or more of said heuristics.

34. The method of claim 33 further comprising:
conducting a second new route processing of any of said circuit blocks that contain at least one new net previously classified as critical.

35. The method of claim 34, wherein said second new route processing comprises:
generating a second new detailed route for said at least one new net previously classified as critical; and
generating a second new actual length for said second new detailed route thereby creating a more improved net.

36. A computer program product having a computer readable medium including computer program logic recorded thereon, the computer program product comprising:
code for monitoring a correlation between an estimated route length and a detailed route length; and
code for utilizing said monitored correlation to identify critical nets.

37. The computer program product of claim 36 further comprising:
code for identifying when said detailed route length is larger than said estimated route length.

38. The computer program product of claim 37 further comprising:
code for calculating said ratio as a quotient of said estimated route length over said detailed route length.

39. The computer program product of claim 37 further comprising:
code for calculating said ratio as a quotient of said detailed route length over said estimated route length.

40. The computer program product of claim 36 wherein:
said code for utilizing said monitored correlation comprises code for identifying critical nets of circuit blocks; and
said code for monitoring a correlation comprises code for conducting placement processing of at least one circuit block of said circuit blocks, wherein placement processing operates to establish a location for all elements of said at least one circuit block.

41. The computer program product of claim 40 wherein said code for conducting placement processing further comprises:
code for generating an estimated route for at least one net of said at least one circuit block, and
code for generating an estimated length for said estimated route.

42. The computer program product of claim 41 further comprising:
code for populating a placement database with placement data; and
code for generating an estimated route report.

43. The computer program product of claim 42 wherein said code for populating a placement database comprises:
code for populating a placement database with information related to said estimated route, wherein said estimated route comprises a collection of shapes on different metal layers of said at least one circuit block.

44. The computer program product of claim 41 wherein said code for monitoring a correlation further comprises:
code for conducting route processing of said at least one circuit block.

45. The computer program product of claim 44, wherein said code for conducting route processing comprises:
code for generating a detailed route for said at least one net of said at least one circuit block; and
code for generating an actual length for said detailed route.

46. The computer program product of claim 45 further comprising:
code for populating a routing database with data related to said detailed route; and
code for generating a detailed route report.

47. The computer program product of claim 45 wherein said code for monitoring a correlation further comprises:
code for calculating a ratio between said estimated length for said estimated route and said actual length for said detailed route wherein said calculated ratio identifies if said actual length for said detailed route is greater than said estimated length for said estimated route.

48. The computer program product of claim 47 wherein said code for utilizing said monitored correlation to identifying critical nets further comprises:
code for establishing a flexible set of heuristics;
code for comparing at least one net of said at least one circuit block with said heuristics; and
code for classifying said net as critical if said net satisfies one or more of said heuristics.

49. The computer program product of claim 48 further comprising:
code for conducting a new route processing of any of said circuit blocks that contain at least one net previously classified as critical.

50. The computer program product of claim 49, wherein said code for conducting a new route processing comprises:
code for generating a new detailed route for said critical net; and
code for generating a new actual length for said critical net thereby creating an improved net.

51. The computer program product of claim 50 further comprising:
code for comparing said improved net with said flexible set of heuristics; and
code for classifying said new net as critical if said new net satisfies one or more of said heuristics.

52. The computer program product of claim 51 further comprising:
code for conducting a second new route processing of any of said circuit blocks that contain at least one new net previously classified as critical.

53. The computer program product of claim 52, wherein said code for conducting a second new route processing comprises:
code for generating a second new detailed route for said at least one new net previously classified as critical; and
code for generating a second new actual length for said second new detailed route thereby creating a more improved net.

54. A system for rerouting at least one net of a circuit, said system comprising:
a means for determining a first length of at least one route of a net;
a means for determining a second length for said at least one route of said net;
a means for comparing said first length to said second length; and
a means for rerouting said at least one net based in part on said comparison.
